(19) United States
(12) Patent Application Publication
(10) Pub. No.: US 2004/0167919 A1
(43) Pub. Date: Aug. 26, 2004

(54) Methods for selectable display of parts of a document on a computer monitor

(76) Inventors: David Sterling, Lyles, TN (US); Athan Gibbs SR., Nashville, TN (US)

Correspondence Address: Carl M. Davis II, Baker, Donelson, Bearman & Caldwell, Suite 900, Five Concourse Parkway, Atlanta, GA, 30328, US

(21) Appl. No.: 10/374,693

(22) Filed: Feb. 24, 2003

(51) Int. Cl. G06F 7/00

(52) U.S. Cl. 707/102

(57) ABSTRACT

If all of a document cannot be displayed on a computer monitor or a designated area of the computer monitor, a part of the document is displayed and a scroll indicator appears on the displayed part to indicate availability of another part of the document. The scroll indicator's placement, appearance and shape may indicate the position of the undisplayed part of the document relative to the displayed part. The area of the document corresponding to where the scroll indicator appears may appear inactive with respect to receiving input. The inactivity is represented by the area having an appearance different from the remainder of the displayed part of the document. If the scroll indicator is activated, another part of the document (not previously included in the displayed part) is displayed. Activation of the scroll indicator affects only the document and does not affect other elements displayed on the computer monitor.

### SUMMARY

The inventions include methods of providing a user with access to view a part or parts of a document that may be available, but are not displayed on a computer monitor or on a designated area of a computer monitor being used by the user.

Generally, the inventions cause one or more scroll indicators to appear on the displayed part of the document to indicate availability of an undisplayed part or parts of the document. The scroll indicator's placement, appearance, and shape convey additional information to the user so that moving around in a document through use of the scroll indicator is intuitive and easy.

The ease and intuitive use of the scroll indicator to move around in a document is facilitated by the features and functions of the scroll indicator such as its placement, appearance, and shape. These features, separately or in combination, may indicate the availability and the relative position of the undisplayed part or parts of the document with respect to the displayed part. From the information conveyed by the scroll indicator, a user may select an undisplayed part of the document to view. The user activates the scroll indicator and has the selected, previously undisplayed part of the document displayed on the computer monitor.

More particularly, the inventions cause one or more scroll indicators to appear on the part of the document displayed on the computer monitor. A particular feature of a scroll indicator is that it appears to be “on top” of a displayed part of the document. By being on top of a displayed part, the scroll indicator quickly and expressly alerts the user that another part or parts of the document are available for viewing. The scroll indicator may block a user's view of the content on which the scroll indicator appears to rest. By blocking some of the content of the displayed part of the document, the scroll indicator conveys the impression to the user that the scroll indicator may be used as an access means to view the blocked content or other undisplayed parts of the document.

Another feature of a scroll indicator is that it may be labeled with a term and/or include a graphic image. The label is used with the scroll indicator to more quickly and expressly convey information about the availability of another undisplayed part or parts of a document. For example, the scroll indicator may be labeled with the term “More” to indicate that more of the document is available for viewing.

Conveniently, yet another feature of the scroll indicator is as an information resource relating to the content of an undisplayed part or parts of a document with respect to the document's organization. This feature of the scroll indicator may be implemented through specific location of a scroll indicator on the displayed part of the document. The location of a scroll indicator on the displayed document may readily convey information to the user about the undisplayed part or parts of the document that are available for viewing. For example, a scroll indicator appearing near the top of the computer monitor indicates the availability of an undisplayed part or parts of the document that precede the displayed part in the organization of the document. Such a scroll indicator may be referred to as a scroll-up indicator. A scroll indicator appearing near the bottom of the computer monitor indicates the availability of an undisplayed part or parts of the document that follow the displayed part of the document. Such a scroll indicator may be referred to as a scroll-down indicator.

Similarly, a scroll indicator may be a scroll-lateral indicator for selectively viewing a lateral part of the document. If the scroll-lateral indicator is activated, then a lateral part of the document is displayed.

Further, a scroll indicator appearing near the right or left side of the computer monitor indicates the availability of an undisplayed part or parts of the document that are located respectively to the right or left side of the displayed part of the document in the organization of the document. A scroll-right indicator indicates availability of an undisplayed part or parts of the document to the right of the displayed part of the document. A scroll-left indicator indicates availability of an undisplayed part or parts of the document to the left of the displayed part of the document. The number and type of scroll indicators appearing on the displayed part of the document depends on the availability of an undisplayed part or parts of the document.

The shape of a scroll indicator is another of its features that may serve as an information resource relating to the content of an undisplayed part or parts of a document with respect to the document's organization. The shape of a scroll indicator may readily convey information to the user about the specific undisplayed part or parts of the document that are available for viewing. For example, a scroll indicator having an arrow shape with the arrow pointing towards the top of the computer monitor provides information that an undisplayed part or parts precede the displayed part of the document in the organization of the document.

Similarly, a scroll indicator having an arrow shape with the arrow pointing towards the bottom of the computer monitor provides information that an undisplayed part or parts follow the displayed part of the document. In like fashion, a scroll indicator shaped as an arrow and pointed to the right or to the left provides information that an undisplayed part or parts of the document are located, respectively, to the right or to the left of the displayed part of the document.

Further, another feature of the scroll indicator is that it may operate with an area of the displayed part of the document to indicate availability and possible content of an undisplayed part or parts of a document. The scroll indicator may operate with an area of the displayed part of the document through the scroll indicator's placement in the area. The area may be made to have an appearance different from the remainder of the displayed part of the document.

As another example, the area of the scroll indicator's placement may be made inactive so as to be unable to receive input such as user input. The inactivity of the area and the placement of the scroll indicator with respect to that area indicate to the user that an undisplayed part or parts of the document may be available for viewing.

The inactivity of the area of the scroll indicator's placement may be made apparent to the user by causing the area to have an appearance different from the remainder of the displayed part of the document. For example, the contents of the area may be made to appear as if to fade away from the remainder of the displayed part of the document.

The preceding discussion has referred generally to the use of a single scroll indicator on a displayed document, but more than one scroll indicator may be used. For example, a document may be presented with only the middle or a middle part of the document being displayed on a computer monitor. To indicate the availability of undisplayed parts of the document, a scroll indicator may be placed near the top of the displayed part of the document and another scroll indicator may be placed near the bottom. The scroll indicator near the top indicates the availability of an undisplayed part or parts of the document that precede the displayed part of the document. The scroll indicator near the bottom indicates the availability of an undisplayed part or parts of the document that follow the displayed part of the document.

The number and placement of scroll indicators on the displayed part of a document are determined by the availability and position (relative to the displayed document) of parts of the document that are not displayed.

Advantageously, the inventions may include other features that may be used in connection with the scroll indicator to provide a user with optimal viewing of a document on a computer monitor. An example of such a feature is the enlarge feature. A user may activate the enlarge feature to enlarge the size of the content of the displayed part of the document. As a result, the displayed part of the document may not include as much content as prior to the enlargement. By enlarging the size of the content, less content (but larger) may be contained in the displayed part of the document. With the change in the content of the displayed part of the document, some of the previously displayed part of the document may become “undisplayed”, and available for viewing. A scroll indicator may be made to appear on the displayed document to indicate the availability of the new “undisplayed” part of the document for viewing.

For example, assume a displayed part of a document does not include a scroll indicator. If a user enlarges the content of the displayed part, less content may appear on the computer monitor. With the enlargement of the content, some of the content may disappear off the computer monitor. A scroll indicator appears on the enlarged displayed part of the document to indicate that an undisplayed part or parts of the document are available. If the user is interested in seeing an undisplayed part or parts of the document, the user may activate the appropriate scroll indicator as explained above.

Another feature that may be used in the inventions is the shrink feature. Like the enlarge feature, the shrink feature affects the size of the content of the displayed part of the document. A user may activate the shrink feature to shrink the size of the content of the displayed part of the document. As a result, the displayed part of the document may include more content than it did prior to the shrinking. By shrinking the size of the content, more content may be contained in the displayed part of the document. With the change in the content of the displayed part of the document, some of the previously undisplayed part or parts of the document may become displayed. Thus, the change in the content of the displayed part of the document may lead to the disappearance of one or more scroll indicators. A scroll indicator may disappear because its corresponding undisplayed part of the document has become a displayed part of the document.

Yet another feature of the inventions is that a scroll indicator may be used with respect to a document that is displayed as an element among two or more elements on a computer monitor. Use of the scroll indicator on the document does not affect the other elements displayed on the computer monitor. The disposition of the scroll indicator over the displayed part of the document provides selectable access to the undisplayed part of the document and does not affect the display of the other elements on the computer monitor.

Conveniently, the inventions may be used to determine whether use of a scroll indicator is appropriate. For example, a determination may be made as whether all of a document may be displayed on a computer monitor. If all of the document cannot be displayed, then part of the document may be displayed on the computer monitor, and a scroll indicator may be made to appear on the displayed part to provide selectable access to an undisplayed part or parts of the document.

Particularly, to carry out the determination of whether all of a document may be displayed on a computer monitor, a comparison may be made between the size of the display area of the computer monitor and the size of all of the document. In some cases, the display area may not be the size of the computer monitor, but rather, may be the size of a display area designated for the document as one of two or more elements displayed on the computer monitor. If a check reveals that the size of all of the document allows for its display on the computer monitor, then all of the document may displayed on the computer monitor.

Checking whether all of a document may be displayed on a computer monitor may be carried out in a number of ways depending on the document and on the display area of the computer monitor. For example, the height of all of a document may be compared to the height of the display area on the computer monitor. The width of all of a document may be compared to the width of the display area.

If the size of all of the document does not allow for its display on the computer monitor, then a part of the document may be displayed on the computer monitor. A scroll indicator may be caused to appear on the displayed part of the document to indicate availability of an undisplayed part or parts of the document. As explained above, the scroll indicator may be activated to view an undisplayed part or parts of the document.

In summary, the inventions include methods of providing a user with access to view a part or parts of a document that may be available, but are not displayed on the computer monitor or on a designated area of the computer monitor. The methods include the use of one or more scroll indicators displayed on the displayed part of the document to indicate the availability of an undisplayed part or parts of the document. The scroll indicator's placement, appearance, and shape may convey additional information to the user so that moving around in a document through use of the scroll indicator is very intuitive and easy.

Other objects, features, and advantages of the inventions may be more clearly understood and appreciated from a review of the following detailed description and by reference to the appended drawings and claims.

### BRIEF DESCRIPTION OF THE DRAWINGS

FIG. 1 is a flow diagram including actions of an exemplary embodiment of the inventions.

FIGS. 2A-2D illustrate use of an exemplary embodiment.

FIGS. 3A-3B illustrate use of another exemplary embodiment.

### DETAILED DESCRIPTION

The inventions described herein provide easy and intuitive methods for a user to move around in all of a document when part of that document is partially displayed on a computer monitor and other parts are available for viewing. One or more scroll indicators may be used to implement the inventions as is explained below through the presentation of exemplary embodiments.

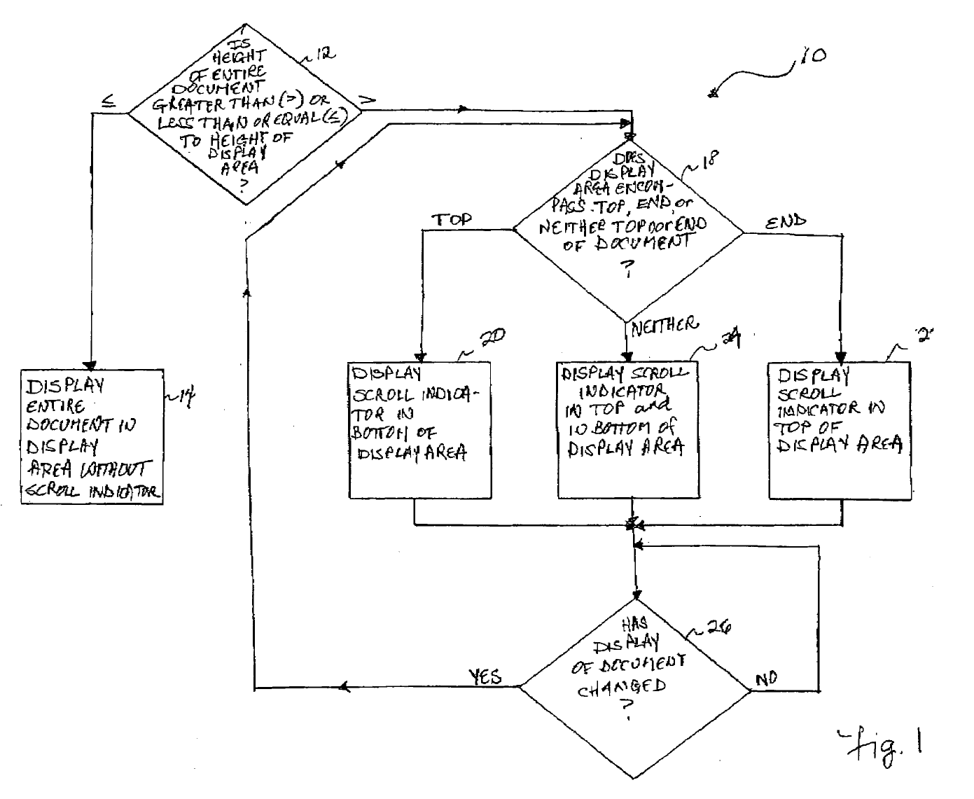

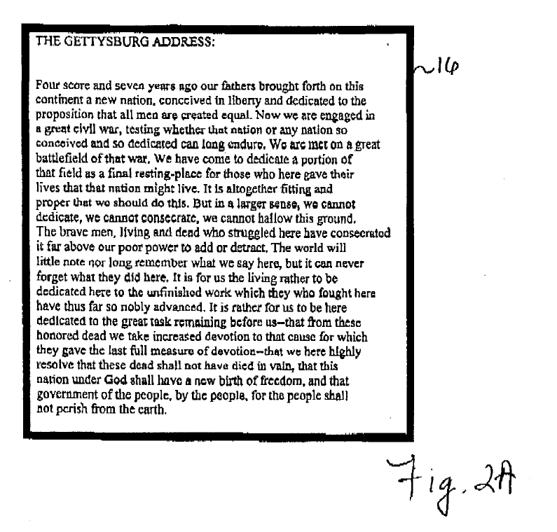

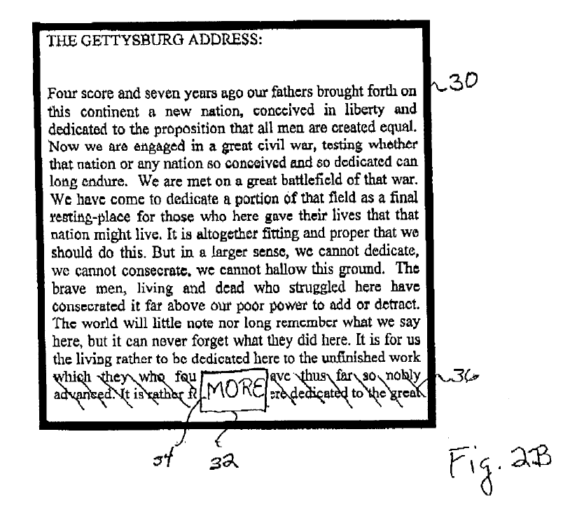

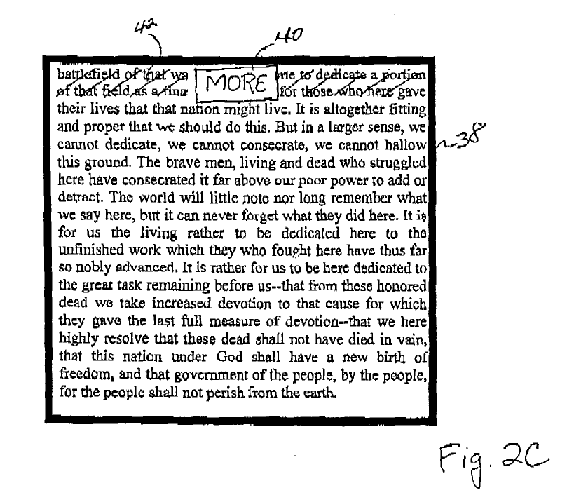

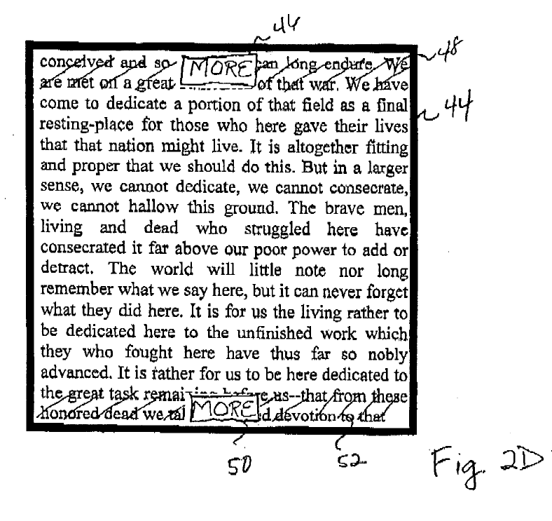

FIG. 1 is a flow diagram describing actions in an exemplary embodiment 10 which determines whether one or more scroll indicators are to be used with a document and where to place them on the document. The actions of FIG. 1 are discussed below with reference to an exemplary document illustrated in FIGS. 2A-2D.

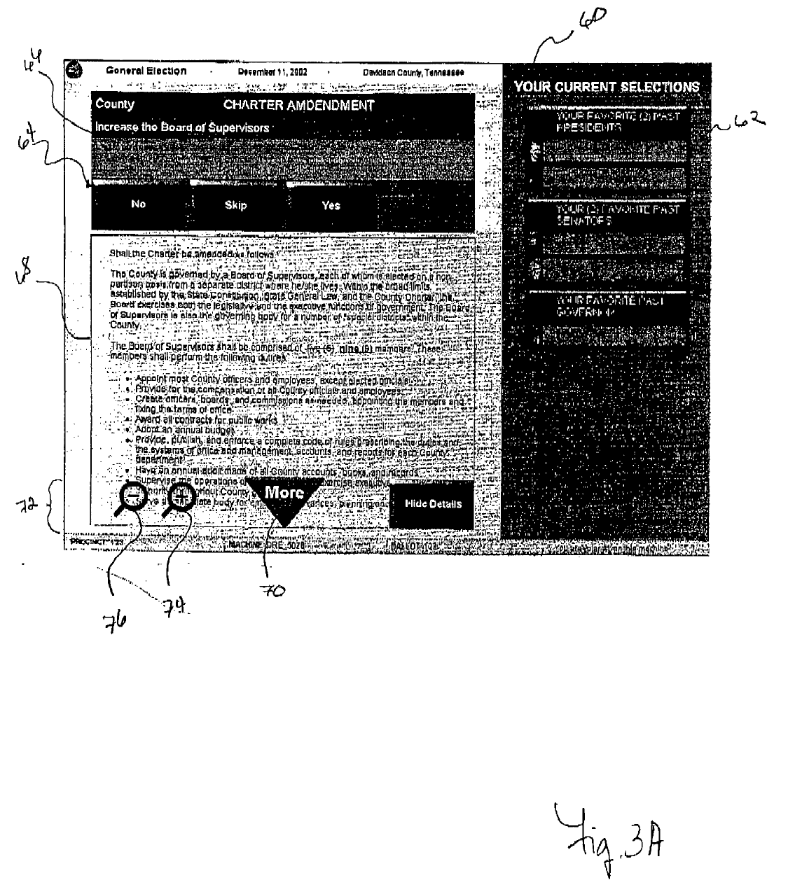

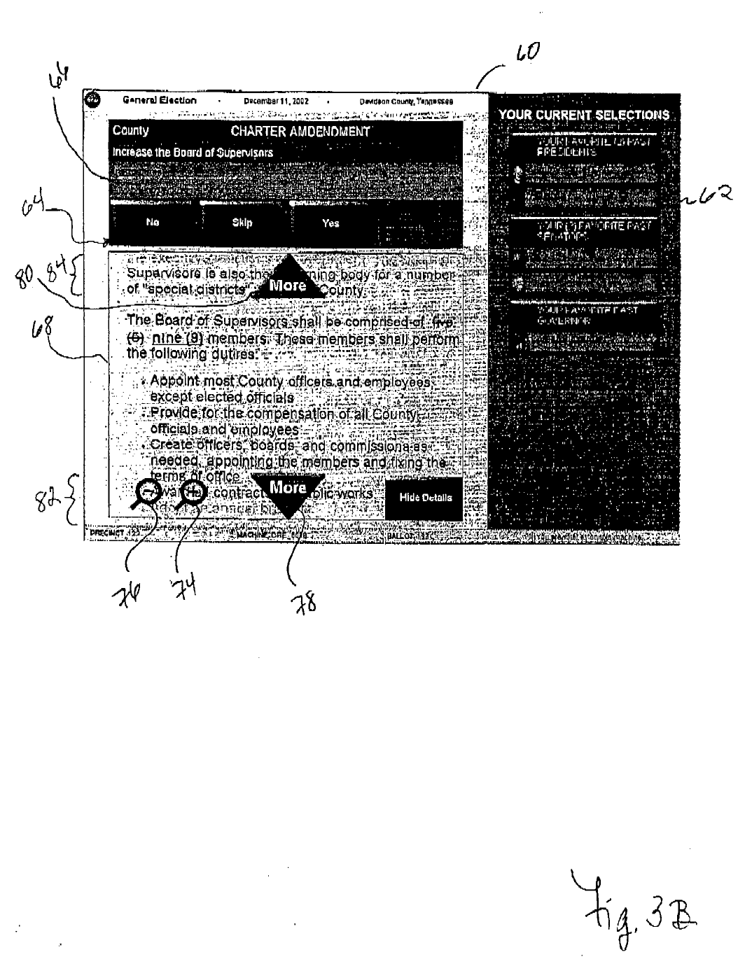

The exemplary document discussed in connection with FIG. 1 and FIGS. 2A-2D is a copy of Lincoln's Gettysburg Address*, which is an all-text document. Nonetheless, a “document” is not limited to being an all-text document. As used herein, the term “document” refers to a set of information that may include text, graphics, charts, tables, spreadsheets, and the like. Moreover, the term “document” may refer to a set of information such as may be transmitted over a data network like a global data network such as the Internet, or may be made to appear on a computer monitor of a user through use of devices that are a part of or have access to a global data network such as the World Wide Web (WWW) or elements thereof such as web sites and web pages. Thus, a document may be authored through Hypertext markup language (HTML), Dynamic HTML (DHTML), HTA applications, and the like, and/or may be a web page or a part thereof. The document discussed in connection with FIGS. 3A-3B is created through use of an HTML application, and is made to appear on computer monitor by Internet access to a server. * Prepared by Gerald Murphy (The Cleveland Free-Net -aa300) Distributed by the Cybercasting Services Division of the National Public Telecomputing Network (NPTN).

In addition, the discussion herein refers to a document being presented or displayed on a “computer monitor”. The term “computer monitor” is used herein synonymously with the terms “monitor”, “computer screen”, “display area”, “display screen”, or “screen”. Those skilled in the art will understand that a document is typically displayed in connection with a user interface on a computer monitor. Nevertheless, as used herein, the term “computer monitor” encompasses presentation of a document through a user interface or otherwise.

Assume for purposes of this first example that a student is required to read the Gettysburg Address. The text of the Gettysburg Address as information provided in a format suitable for word process so that the Gettysburg Address may be presented to the student for reading on a computer monitor at school. A copy of the Gettysburg Address may be provided for use with the computer at school by its inclusion on the computer's hard drive, or the copy may be provided to the student's computer by e-mail, compact disc, or otherwise with the copy in a word processing format.

Alternatively, the student may have to obtain a copy of the Gettysburg Address by on-line research. The student may use a computer to access the and find a Website that includes a copy of the Gettysburg Address, which may be read by the student on his or her computer monitor.

Whether the student is reading the Gettysburg Address on the computer monitor in a word processing format, as presented on a Web page from a Web site, or otherwise, there may be limitations relating to the presentation of all of document on the student's computer monitor. Thus, the student may be presented with only part of the Gettysburg Address on his or her computer monitor. An exemplary embodiment of the inventions provides an easy and intuitive method for the student to selectively have the other parts of the document presented on the computer monitor.

As a first action, the exemplary method checks whether use of a scroll indicator is appropriate by checking whether all of the Gettysburg Address may be displayed on the computer monitor. As used herein, the term “all of” is synonymous with and may be used interchangeably with the terms “the whole”, “the complete”, or “the entire”.

As indicated by check block 12 in FIG. 1, to check whether us of a scroll indicator is appropriate, a comparison is made between the height of the entire Gettysburg Address and the height of the display area. Specifically, a determination is made as to whether the height of the entire document is greater than or less than/equal to the height of the display area.

In the example of the Gettysburg Address, the only size comparison that is carried out with respect to the use of a scroll indicator is the comparison between the height of the document and the height of the display area on the computer monitor. Among the reasons for limiting the size comparison to height in this example is that text documents such as the Gettysburg Address are typically read in a top down manner. Thus, if a scroll indicator is to be used, a scroll-down and/or scroll up indicator may be the most familiar to a user, and thus, the most convenient. Nonetheless, the inventions are not limited to only a height comparison, but may make different or additional size comparisons.

For example, a width comparison may be carried out when appropriate such as with respect to a spreadsheet or other such document that may be read in a left to right manner. If the comparison results in a finding that the width of the spread sheet is wider than the display area, then a scroll-lateral indicator may be made to appear on the screen. Use of the scroll-lateral indicator results in display of a previously undisplayed lateral part of the document. The scroll-later indicator may include a scroll-right indicator or a scroll-left indicator. A scroll-up indicator and/or a scroll-down indicator may also appear on the screen if a height comparison results in a finding that the height of the spread sheet is greater than the height of the display area.

Referring again to FIG. 1, if the determination results in a finding that the entire document may be displayed, then a scroll indicator is unnecessary. There is no additional part or part(s) of the document available to the user. The document is displayed on the computer monitor as indicated by action block 14 of FIG. 1, and is displayed without a scroll indicator. Specifically, if the determination in action 12 is that the height of the entire document is greater than the height of the display area, then all of the Gettysburg Address 16 is displayed on the computer monitor as illustrated in FIG. 2A, and is displayed without a scroll indicator. Advantageously, there is no scroll indicator to distract the user's reading of the Gettysburg Address as it appears completely on the computer monitor.

If the check in action 12 results in the determination that all of the document cannot be displayed, then a part of the document is displayed with a scroll indicator. Action 18 presents a decision block that represents the action of determining which part of the document is displayed as part of the decision making process regarding which scroll indicator(s) to display and its placement. The parts of the document that may be or are displayed include at least the top, the bottom, and a part that includes neither the top nor the bottom. Action 18 of FIG. 1 checks whether the top, the bottom, or neither the top nor the bottom of the document are to be or are displayed. A document typically is first displayed by including its top or beginning. But an action of the user or other may have resulted in the document being presented in another manner such as without the top or beginning of the document.

As used herein, the term “top” as in “top of the document” may be used synonymously with the terms “beginning” or “start”. In other words, the “top” of a document is the part of the document that includes the first text, graphic images, etc. of the document. Also as used herein, the term “bottom” as in “bottom of the document” may be used synonymously with the terms “end” or “finish”. The “bottom” of a document is the part of the document that includes the last text, graphic images, etc. of the document.

If the check of action 18 in FIG. 1 results in a finding that the top of the document is to be or is included in the displayed part of the document, then in action 20 a scroll indicator is made to appear on the displayed part of the document and near its bottom. The reasoning for this placement of the scroll indicator follows. If the top of the document is included in the displayed part, then there is a part or parts of the document that follow the top part and that are not included in the displayed part of the document. This other non-displayed part or parts are available for selection and view by the user.

Advantageously, the exemplary embodiment expressly conveys information to the user that an undisplayed part or parts of the document are available for viewing and that they follow the top of the document in the organization of the document. Specifically, to convey the information to the user, a scroll indicator is presented on the displayed part of the document near the bottom of the display area on the computer monitor.

FIG. 2B illustrates a computer monitor displaying a portion of the Gettysburg Address including its top. FIG. 2B further illustrates a scroll indicator 32 that is caused to appear on the displayed part of the document and near the bottom. The scroll indicator 32 appears as if it is placed “on top” of some of the text of the Gettysburg Address. The appearance of the scroll indicator 32 on top of the Gettysburg Address expressly conveys to the user that additional information may be available for viewing.

In this example, the appearance of the scroll indicator on top of the Gettysburg Address results in a cover-up of some of the text. The user cannot read what appears to be “underneath” the scroll indicator. The inability to read part of the text that appears to be underneath the scroll indicator is another feature of the inventions to expressly convey to the user that additional information may be available. The scroll indicator's blocking of underlying text from a user's view deliberately alerts the user to the scroll indicator's presence and the significance of that presence regarding the availability of additional information.

As noted, in the example discussed in connection with FIG. 1 and FIGS. 2A-2D, the scroll indicator blocks a user's view of the text of the Gettysburg Address that appears to lie underneath the scroll indicator. But the inventions are not limited to a scroll indicator that is opaque. The body of the scroll indicator or other parts may be transparent or partially transparent.

Further in the example discussed in connection with FIG. 1 and FIGS. 2A-2D, the scroll indicator is of a rectangular shape and of a particular size. Nevertheless, a scroll indicator may assume other shapes and sizes. Moreover, if more than one scroll indicator is caused to appear on a displayed document, the size and/or shape of the scroll indicators do not have to match or otherwise correspond.

As a further feature of the example discussed in connection with FIG. 1 and FIGS. 2A-2D, the scroll indicator displays the term “More”. The use of the term “More” on the scroll indicator conveys to the user the impression that additional information such as an undisplayed part or parts of the document are available for selection and view. But the inventions are not to be limited to the use of the term “More” nor any other specific term. Another term or terms may be used on the scroll indicator to convey to the user that additional information may be available.

Further, the inventions are not to be limited to the use of a term or terms to convey the message that additional information may be available. A graphic image or images may be used instead of a term or terms or with a term or terms. For example, a scroll indicator may bear the likeness of an arrow or triangle to indicate the availability of additional information. The direction of the arrow or apex of the triangle may convey to the user information about the content of the additional information such as whether the additional information includes a part or parts of a document that precede or follow the displayed part.

FIG. 2B illustrates another feature of the scroll indicator 32 referred to as the “inactivity feature“ herein. The inactivity feature is another means to convey to the user that additional information may be available. Generally, in the inactivity feature, an area of the displayed part of the document is caused to be inactive with respect to input. In other words, it is not possible to activate (such as by clicking-on a word or image) the content within the area of the displayed part subject to the inactivity feature. The area is in the vicinity of the placement of a scroll indicator on the displayed part of the document. The inactivity of the area conveys to the user the message that additional information may be available. Moreover, the relative position of the inactive area with respect to the displayed part of the document conveys information on the content of the available information.

Referring to FIG. 2B, an area 36 is located in the vicinity of the placement of the scroll indicator 32 near the bottom of the displayed part of the document. The area's location and the scroll indicator's placement conveys information to the user regarding the availability and content of an undisplayed part or parts of the document. Another feature that conveys information regarding the availability of an undisplayed part or parts of the document is that the appearance of the area 36 is different from the appearance of the remainder of the displayed part of the document. In this example, the appearance of the area 36 is different because it is cross-hatched.

Further, the area 36 of the scroll indicator's placement may be made inactive so as to be unable to receive input such as user input. The inactivity of the area 36 and the placement of the scroll indicator 32 with respect to that area 36 indicate to the user that an undisplayed part or parts of the document may be available for viewing. Further, the inactivity of the area 36 and the placement of the scroll indicator 32 near the bottom of the displayed part of the area indicate that the undisplayed part or parts follow the displayed part of the document.

The inactivity of the area 36 of the scroll indicator's placement may be made apparent to the user by causing the area to have an appearance different from the remainder of the displayed part of the document 30. Referring to FIG. 2B, the area 36 of the scroll indicator's placement includes the bottom of the displayed part of the document and a sub-part of the displayed document 30 that would be covered by the scroll indicator 32 if the scroll indicator extended from the left to the right margin across the displayed part of the document 30. Further, the area 36 is made to appear different from the remainder of the displayed part of the document 30 by cross-hatching covering the area 30. Other examples of how the area may appear different include the use of bolding, italicizing, underlining, fading, capitalization, change in font size, change in color, change in format, etc.

Reference is made again to FIG. 1 and to the check action 18 that determines what part of the document is to be or is displayed. If the check of action 18 results in a finding that the bottom of the document is to be or is included in the displayed part of the document, then in action 22 a scroll indicator is made to appear on the displayed part of the document and near the top of the document. The reasoning for the placement of the scroll indicator near the top of the displayed document in this example is analogous to that of the example presented above in connection with the placement of a scroll indicator near the bottom of the displayed part. The placement of the scroll indicator near the top readily conveys to the user that more of the document is available, and that the available part or parts of the document precede the displayed part.

FIG. 2C illustrates a computer monitor displaying a portion of the Gettysburg Address including its end. FIG. 2C further illustrates a scroll indicator 40 that is caused to appear on the displayed part of the document and near its top. The placement of the scroll indicator 40 near the top indicates the availability of an undisplayed part or parts of the document that precede the displayed part.

FIG. 2C also illustrates an area 42 used in connection with the inactivity feature of the inventions. Area 42 is inactive with respect to the receipt of input. Area 42 is located in the vicinity of the placement of the scroll indicator 40 near the top of the displayed part of the document. The inactivity of the area 42 and the placement of the scroll indicator 40 with respect to that area 42 indicate to the user the availability of an undisplayed part or parts of the document that precede the displayed part. The inactivity of area 42 is made apparent to the user by cross-hatching.

Reference is made yet again to FIG. 1 and to the check action 18 that determines what part of the document is to be or is displayed. If the check of action 18 results in a finding that neither the top nor the bottom of the document is to be or is included in the displayed part of the document, then in action 24 two scroll indicators are made to appear on the displayed part of the document. One of the scroll indicators is placed near the top of the document indicating that an undisplayed part or parts of the document preceding the displayed part are available. The other of the scroll indicators is placed near the bottom of the document indicating that an undisplayed part or parts of the document following the displayed part of the document are available.

FIG. 2D illustrates a computer monitor displaying a portion of the Gettysburg Address 44 including neither the top nor the bottom. FIG. 2D further illustrates a scroll indicator 46 that is caused to appear on the displayed part of the document near its top to indicate that an undisplayed part or parts of the document preceding the displayed part are available.

FIG. 2D also illustrates an area 48 used in connection with the inactivity feature of the inventions. Area 48 is inactive with respect to the receipt of input. Area 48 is located in the vicinity of the placement of the scroll indicator 46 near the top of the displayed part of the document. The inactivity of the area 48 and the placement of the scroll indicator 40 with respect to that area 48 indicate to the user the availability and information on the content of an undisplayed part or parts of the document that precede the displayed part. The inactivity of area 42 is made apparent to the user by cross-hatching.

In addition, FIG. 2D illustrates a scroll indicator 50 that is caused to appear on the displayed part of the document near its bottom to indicate that an undisplayed part or parts of the document following the displayed part are available.

FIG. 2D also illustrates an area 52 used in connection with the inactivity feature of the inventions. Area 52 is inactive with respect to the receipt of input. Area 52 is located in the vicinity of the placement of the scroll indicator 50 near the bottom of the displayed part of the document. The inactivity of the area 52 and the placement of the scroll indicator 50 with respect to that area 52 indicate to the user the availability and information on the content of an undisplayed part or parts of the document. The inactivity of area 52 is made apparent to the user by cross-hatching.

In the example discussed in connection with FIG. 1 and FIGS. 2A-2D, one or more scroll indicators is used in connection within an area in the vicinity of the placement of the scroll indicator and that is inactive with respect to input. But the inventions should not be limited to the inclusion of a scroll indicator with the scroll indicator being used in connection with an area having an inactivity feature. The use of an area with the scroll indicator is an option as is use of the inactivity feature. The use of the area with the scroll indicator and the inactivity feature serve as additional mechanisms for alerting the user to the availability and information on the content of an undisplayed part or parts of the document.

After a scroll indicator or indicators is displayed as described above in connection with FIGS. 2B-2D, the exemplary inventions monitor the display of the document to determine whether any changes are necessary with respect to the display of a scroll indicator or indicators. Thus, in action 26 in FIG. 1, the exemplary embodiment checks whether the display of the document has changed. If it has changed, then some change may be necessary with respect to the display and placement of a scroll indicator or indicators. If the check determines that no changes have occurred to the display of the document, then the exemplary embodiment continues to monitor for changes as indicated by action 26. On the other hand, if a change has occurred in the display of the document, then the exemplary embodiment returns to action 18 of FIG. 1 (and the actions thereafter) to determine whether the changed display encompasses the top, the bottom or neither the top nor bottom of the document, and how to respond to the change.

In sum, per the exemplary embodiment described in connection with FIG. 1 and FIGS. 2A-2D, the student who is assigned to read the Gettysburg Address may make use of the described scroll indicator(s) to view an undisplayed part or parts of the Gettysburg Address.

FIGS. 3A and 3B illustrate another exemplary embodiment of the inventions. In particular, FIGS. 3A and 3B illustrate screen displays that may be presented to a voter on a computer monitor used as part of the voting process. The screen displays may be presented as web pages that may be provided on the computer monitor through a connection over the Internet to a server.

The screen display 60 of FIG. 3A includes two general parts including a “Your Current Selections” (YCS) part 62 and a “Charter Amendment” (CA) part 64. As its name implies, the YCS part 62 displays the selections made by the voter with respect to certain questions or issues.

The CA part 64 of the screen display 60 presents the voter with an issue to be decided, information related to the issue, and voting buttons. In particular, the CA part 64 includes a part 66 presenting the issue and the voting buttons, and a document 68 with information related to the issue. In this example, the document 68 presents the voter with a text of the proposed amendment at issue. Document 68 may be presented to the user as an DHTML document. Document 68 is presented in a designated area of the computer monitor. In other words, document 68 does not take up the whole display area of the computer monitor, but rather, is an element among other elements displayed on the computer monitor. The inventions may be used in connection with document 68 without affecting the other elements on the computer monitor. Advantageously, the inventions may be used in connection with a document that is displayed on less than a whole computer monitor.

An exemplary embodiment of the inventions provides a method to display all or part of the document in the designated area of the computer monitor. If part of the document is displayed, then the exemplary embodiment provides a user with an intuitive and easy to understand manner of accessing the undisplayed part of the document.

The exemplary embodiment associated with FIGS. 3A-3B is implemented through use of an DHTML application. A document 68 that is used with the exemplary embodiment is implemented as an HTML component such as by using document division elements. Specifically, an outermost DIV section houses or encompasses the document. Within the outermost DIV is a scrollable div that defines what part of the document 68 is displayed in the designated area of the computer monitor. The document is parented by the scrollable div so that no changes need to be made to the document with regard to scrolling. The outermost DIV defines a “clipping” region so that any part of the document that is not included in the scrollable div is not displayed on the computer monitor.

Reference to FIG. 3A reveals that only part of the document 68 is displayed in the designated area of the computer monitor. Referring to the exemplary implementation of the document having been written as DHTML as an HTML application, the displayed part of the document is defined by a scrollable div with the entire document being encompassed by the outermost DIV.

As noted, reference to document 68 as shown in FIG. 3A reveals that only part of the document is displayed in the designated area. The user, however, is expressly alerted to the availability of additional information by the scroll indicator 70 appearing to be placed on top of the displayed part of the document 68.

In this example, features of the scroll indicator 70 also convey information to the user. The scroll indicator 70 includes the term “More” to indicate to the user that additional information is available. Further, the scroll indicator 70 is triangular or arrow-like in shape with the point directed towards the bottom of the displayed part of the document. This shape conveys to the user that additional information is available and follows the displayed part of the document in the document's organization.

The user is further alerted to the presence of the scroll indicator 70, and thus, to the availability of additional information, by the opaque quality of the scroll indicator 70. The user cannot see through or read through the scroll indicator 70, and to access such underlying information, the user must activate the scroll indicator 70.

As noted, the scroll indicator 70 appears as if it has been placed “on top” of the text of the displayed part of the document 68. In this example, the scroll indicator 70 is made to appear on top of the text by the z-positioning feature of the DHTML application. The scroll indicator 70 is created using a graphic file. The scroll indicator 70 in is drawn over the outermost DIV. To cause the term “More” to appear on top of the scroll indicator 70, the term “More” is given a z-position higher than the scroll indicator 70. In other words, the term “More” has a higher z-order value than the scroll indicator 70.

As illustrated in FIG. 3A, the scroll indicator 70 is placed near the bottom of the displayed part of the document. The positioning of the scroll indicator 70 near the bottom of the displayed part of the document 68 conveys information on the content of the additional information. Being near the bottom, the scroll indicator 70 alerts the user that additional information follows the displayed parts in the organization of the document.

Further, in the example shown in FIG. 3A, the scroll indicator 70 is used in connection with an area 72 of the displayed part of the document to indicate that an undisplayed part or parts of the document are available to the user. Area 72 is located in the vicinity of the placement of the scroll indicator 70 near the bottom of the displayed part of the document. The scroll indicator 70 and the area 72, being near the bottom of the displayed part, indicate that the undisplayed part or parts follow the displayed part of the document in its organization.

Another feature that conveys information regarding the availability of an undisplayed part or parts of the document is that the appearance of the area 72 is different from the appearance of the remainder of the displayed part of the document. In this example, the appearance of the area 72 is different because the text within the area 72 appears to “fade away” in the direction of the bottom of the designated area of display. In the exemplary embodiment, the effect of fading away is created in the area 72 by using a graphic format that supports an alpha filter. A gradient image is created, with varying alpha levels (from 0% to 100%). This results in the content under the translucent (alpha level=0%) portion of the graphic image showing through, while the content under the opaque (alpha level=100%) portion of the graphic image does not show through.

Further, the area 72 of the scroll indicator's placement may be made inactive so as to be unable to receive input such as user input. In the exemplary embodiment, a translucent item is placed over the top of area 72 in order to make the area 72 (including content within the area) inactive, but still visible.

The inactivity of the area 72 and the placement of the scroll indicator 70 with respect to that area 72 indicate to the user that an undisplayed part or parts of the document may be available for viewing. Further, the inactivity of the area 72 and the placement of the scroll indicator 70 near the bottom of the displayed part of the area indicate that the undisplayed part or parts follow the displayed part of the document in the organization of the document.

Advantageously, the example discussed in connection with FIGS. 3A-3B illustrate other features that may be used in connection with the scroll indicator to provide a user with optimal viewing of a document on a computer monitor. Examples of such features are the enlarge feature 74 and the shrink feature 76. A user may activate the enlarge feature 74 to enlarge or make bigger the size of the content of the displayed part of the document. The user may activate the shrink feature to shrink or make smaller the size of the content of the displayed part of the document.

In this exemplary embodiment, the availability of the enlarge feature 74 is indicated to the viewer by a representation of a magnifying glass including a plus sign (+). The availability of the shrink feature is indicated by a representation of a magnifying glass including a minus sign (−). FIG. 3A illustrates the two magnifying glasses 74, 76 near the bottom of the displayed part of the document 68.

The exemplary embodiment described in connection with FIGS. 3A-3B allows for use of the enlarge and shrink features in connection with the use of a scroll indicator with respect to the document 68. For example, a user may consider the size of the font of the text in document 68 to be too small to read. The user may activate the enlarge feature by clicking-on the magnifying glass including the plus sign 74. The more clicks the user makes the more enlarged the content of the document becomes.

FIG. 3B illustrates an exemplary result of a user's activation of the enlargement feature with respect to the content of the document 68. Note: the use of the enlargement feature including the resulting changes in the text of the displayed document and the scroll indicator(s) only affects the designated area of the computer monitor for displaying the document 68 or parts thereof. The other elements displayed on the computer monitor remain unaffected.

Referring to FIG. 3B, the text of the displayed part of the document 68 has a larger font than the text of the displayed part in FIG. 3A. As a result, the displayed part of the document 68 does not include as much content as prior to the enlargement. With the change in the content of the displayed part of the document 68, some of the previously displayed part of the document becomes “undisplayed”. Nevertheless, these newly undisplayed parts of the document are available for viewing as indicated by the scroll indicators 78, 80.

Once the content of the displayed part of the document 68 changes, the exemplary embodiment checks whether the top, the end, or neither the top nor the end of the document are displayed in the designated area. In this example, the result of the check is that neither the top nor the end of the document are displayed. Consequently, the exemplary embodiment causes two scroll indicators 78, 80 to appear on top of the text of the displayed part of the document.

The scroll indicator 78 is made to appear near the bottom of the displayed part of the document 68 to indicate that additional information follows the displayed part of the document 68. The scroll indicator 78 looks like and is positioned like the scroll indicator 70 in FIG. 3A. Also like in FIG. 3A, the exemplary embodiment causes an area 82 in the vicinity of the scroll indicator 78 to be inactive and to have a fading away appearance that is different from the remainder of the displayed part of the document 68.

As shown in FIG. 3B, as a result of the enlargement of the content of the displayed part of the document 68, the top of the document is no longer displayed in the designated area of the computer monitor. Yet, the top is available to the user. The availability of the top is indicated to the user by depiction of a scroll indicator 80 near the top of the displayed part of the document 68. The scroll indicator 80 near the top is analogous to the scroll indicator 78 near the bottom of the displayed part of the document except that the scroll indicator 80 near the top indicates the availability of additional information that precedes the displayed part of the document.

Similar to the faded inactive area 82 in the vicinity of the scroll indicator 78 near the bottom of the displayed part of the document, FIG. 3B illustrates a faded inactive area 84 in the vicinity of the scroll indicator 80 near the top. The faded inactive area 84 near the top is analogous to the faded inactive area 82 near the bottom except that faded inactive area 84 near the top indicates, like the scroll indicator near the top 80, the availability of additional information that precedes the displayed part of the document. Also, the faded inactive area 84 near the top is different from the faded inactive area 82 near the bottom in that the faded inactive area 84 near the top fades away towards the top of the displayed part of the document.

Advantageously, the user can use the scroll indicator 78 near the bottom to obtain additional information that follows the displayed part of the document and/or use the scroll indicator 80 near the top to obtain preceding additional information. Further, the user may continue to enlarge the content of the document using the enlarge feature as represented by the magnifying glass with the +74, or shrink the content using the shrink feature as represented by the magnifying glass with the − sign 76.

Note: the user is able to move about in the document using the scroll indicators 78, 80, and is able to use the enlarge and shrink features without affecting the other elements on the computer monitor.

The exemplary embodiment described in connection with FIGS. 3A-3B is described as being used with only a single document displayed on the computer monitor. But the inventions should not be limited to use with only one document at a time on a computer monitor. More than one element on a computer monitor may be designated as a document for use with the inventions. For example, referring to FIGS. 3A-3B, the YCS element 62 may be used with an exemplary embodiment of the inventions as well as the document 68. The implementation of an exemplary embodiment with the YCS element 62 may be configured such that the contents of the YCS element, as an DHTML document, are housed in an outermost DIV section. The part of the contents that is displayed is defined by a scrollable div.

In sum, per the exemplary embodiment described in conncton with FIGS. 3A-3B, a voter may use the described exemplary embodiment to move around in the document 68 that presents the proposed amendment at issue to view an undisplayed part or parts of the proposed amendment.

From the foregoing description of the exemplary embodiments of the inventions and operations thereof, other embodiments will suggest themselves to those skilled in the art. Therefore, the scope of each of the inventions is to be limited only by the claims below and equivalents thereof.

We claim:

1. A method for determining whether all of a document may be displayed on a computer monitor, and if all of the document cannot be displayed, displaying part of the document on the computer monitor, and providing selectable access to an undisplayed part of the document, the method comprising:
checking if a size of all of the document allows for its display on the computer monitor;
if the size of all of the document allows for its display on the computer monitor, then displaying all of the document on the computer monitor; and
if the size of all of the document does not allow for its display on the computer monitor, then
displaying a part of the document on the computer monitor,
causing a scroll indicator to appear on the displayed part of the document, and
if the scroll indicator is activated, displaying on the computer monitor another part of the document not included in the displayed part of the document.

2. The method of claim 1, wherein a portion on which the scroll indicator appears is represented by an area having an appearance different from a remainder of the displayed part of the document.

3. The method of claim 2, wherein the different appearance comprises a fading away of contents of the area of the displayed part of the document on which the scroll indicator is displayed.

4. The method of claim 1, wherein the computer monitor comprises a designated area for display of all of the document or for parts of the document;
wherein checking if the size of all of the document allows for its display comprises checking if the size of all of the document allows for its display on the designated area of the computer monitor;
wherein, if the size of all of the document allows for its display on the computer monitor, then displaying all of the document on the designated area of the computer monitor; and
if the size of all of the document does not allow for its display on the computer monitor, then
displaying a part of the document on the designated area of the computer monitor, and
if the scroll indicator is activated, displaying on the designated area of the computer monitor another part of the document not included in the displayed part of the document.

5. The method of claim 1, wherein checking if the size of all of the document may be displayed on the computer monitor comprises checking if a height of all of the document is greater than a height that may be displayed on the computer monitor.

6. The method of claim 1, wherein checking if the size of all of the document may be displayed on the computer monitor comprises checking if a height of all of the document is less than or equal to a height that may be displayed on the computer monitor.

7. The method of claim. 1, wherein checking if the size of all of the document may be displayed on the computer monitor comprises checking if a width of all of the document is greater than a width that may be displayed on the computer monitor.

8. The method of claim 1, wherein checking if the size of all of the document may be displayed on the computer monitor comprises checking if a width of all of the document is less than or equal to a width that may be displayed on the computer monitor.

9. The method of claim 1, wherein the scroll indicator appears on an area of the displayed part of the document; and
wherein the area of the displayed part of the document is inactive with respect to receiving input.

10. The method of claim 1, wherein the inactivity of the area of the displayed part of the document on which the scroll indicator appears is represented by the area having an appearance different from a remainder of the displayed part of the document.

11. The method of claim 10, wherein the different appearance comprises a fading away of contents of the area of the displayed part of the document on which the scroll indicator is displayed.

12. The method of claim 1, wherein causing the scroll indicator to appear on the displayed part of the document comprises causing the scroll indicator to indicate an option for display of the another part of the document.

13. The method of claim 1, wherein the scroll indicator comprises a shape indicating whether the another part of the document precedes or follows the displayed part of the document.

14. The method of claim 13, wherein the shape comprises an arrow indicating the another part of the document precedes the displayed part of the document.

15. The method of claim 1, wherein the scroll indicator indicates availability of a preceding part of the document as the another part of the document.

16. The method of claim 1, wherein the scroll indicator indicates availability of a following part of the document as the another part of the document.

17. The method of claim 1, wherein displaying the displayed part of the document comprises displaying a top of the document.

18. The method of claim 17, wherein causing the scroll indicator to appear on the displayed part of the document comprises causing the scroll indicator to appear near the bottom of the displayed part of the document.

19. The method of claim 18, wherein the scroll indicator comprises a scroll-down indicator;
wherein the another part of the document not included in the displayed part of the document comprises at least a part of the document following the displayed part of the document; and
wherein, if the scroll-down indicator is activated, part of the document following the displayed part of the document is displayed.

20. The method of claim 1, wherein displaying the part of the document comprises displaying an end of the document.

21. The method of claim 20, wherein causing the scroll indicator to appear on the displayed part of the document comprises causing the scroll indicator to appear near the top of the displayed part of the document.

22. The method of claim 21, wherein the scroll indicator comprises a scroll-up indicator;
wherein the another part of the document not included in the displayed part of the document comprises at least a part of the document preceding the displayed part of the document; and
wherein, if the scroll-up indicator is activated, part of the document preceding the displayed part of the document is displayed.

23. The method of claim 1, wherein displaying the part of the document comprises displaying a part of the document without displaying a top of the document or a bottom of the document.

24. The method of claim 23, wherein the scroll indicator comprises a scroll-down indicator and a scroll-up indicator;
wherein the scroll-down indicator is displayed near the top of the displayed part of the document;
wherein the scroll-up indicator is displayed near the bottom of the displayed part of the document;
wherein the another part of the document not included in the displayed part of the document comprises at least a following part of the document and at least a preceding part of the document, with the following part of the document following the displayed part of the document in the document, and with the preceding part of the document preceding the displayed part of the document in the document;
wherein, if the scroll-down indicator is activated, a following part of the document is displayed; and
wherein, if the scroll-up indicator is activated, a preceding part of the document is displayed.

25. The method of claim 1, further comprising:
displaying an enlarge feature on the displayed part of the document for selectively enlarging content of the displayed part of the document; and
if the enlarge feature is activated, enlarging the content of the displayed part of the document.

26. The method of claim 1, further comprising:
displaying a shrink feature on the displayed part of the document for selectively shrinking content of the displayed part of the document; and
if the shrink feature is activated, shrinking the content of the displayed part of the document.

27. With respect to a part of a document displayed on a computer monitor, a method for providing selectable access to an undisplayed part of the document, the method comprising:
causing a scroll indicator to appear over the displayed part of the document; and
if the scroll indicator is activated, displaying another part of the document not included in the displayed part of the document.

28. The method of claim 27, wherein causing the scroll indicator to appear over the displayed part of the document comprises causing the scroll indicator to appear over some content of the displayed part of the document so that the scroll indicator blocks viewing of the some content of the document.

29. The method of claim 27, wherein the scroll indicator comprises a scroll-up indicator for selectively viewing a preceding part of the document and a scroll-down indicator for selectively viewing a following part of the document; and
wherein, if the scroll-up indicator is activated, displaying the preceding part of the document, and if the scroll-down indicator is activated, displaying the following part of the document.

30. The method of claim 27, wherein the scroll indicator comprises a scroll-lateral indicator for selectively viewing a lateral part of the document; and
wherein, if the scroll-lateral indicator is activated, displaying a lateral part of the document.

31. The method of clalim 27, wherein a portion of the displayed part of the document on which the scroll indicator appears is represented by an area having an appearance different from a remainder of the displayed part of the document.

32. The method of claim 31, wherein the different appearance comprises a fading away of contents of the area of the displayed part of the document on which the scroll indicator is displayed.

33. With respect to a computer monitor displaying one or more elements including a displayed part of a document as an element, a method for providing selectable access to an undisplayed part of the document without affecting display of other elements, the method comprising:
causing at least a scroll indicator to be disposed over the displayed part of the document;
causing activation of the scroll indicator to affect only the document; and
if the scroll indicator is activated, displaying another part of the document not included in the displayed part of the document,
whereby the disposition of the scroll indicator over the displayed part of the document provides selectable access to the undisplayed part of the document and does not affect the display of the other elements on the computer monitor.

34. The method of claim 33, wherein the scroll indicator comprises a scroll-right indicator;
wherein the another part of the document comprises a right part of the document; and
wherein, if the scroll-right indicator is activated, displaying the right part of the document.

35. The method of claim 28, wherein the scroll indicator comprises a scroll-left indicator;
wherein the another part of the document comprises a left part of the document; and
wherein, if the scroll-left indicator is activated, displaying the left part of the document.

36. The method of claim 33, wherein the scroll indicator comprises a scroll-up indicator for selectively viewing a preceding part of the document and a scroll-down indicator for selectively viewing a following part of the document; and
wherein, if the scroll-up indicator is activated, displaying the preceding part of the document, and if the scroll-down indicator is activated, displaying the following part of the document.

37. The method of claim 33, wherein a portion of the displayed part of the document on which the scroll indicator appears is represented by an area having an appearance different from a remainder of the displayed part of the document.

38. The method of claim 37, wherein the different appearance comprises a fading away of contents of the area of the displayed part of the document on which the scroll indicator is displayed.
